(19) United States
(12) Patent Application Publication
(10) Pub. No.: US 2010/0321670 A1
(43) Pub. Date: Dec. 23, 2010

(54) Apparatus for measuring the displacement of a valve rod of a motor-operated valve and transmitting a related signal

(75) Inventor: Tzu-Chin Kuo, Taoyuan county (TW)

Correspondence Address: Jackson Intellectual Property Group PLLC, 106 Starvale Lane, Shipman, VA, 22971, US

(73) Assignee: ATOMIC ENERGY COUNCIL - INSTITUTE OF NUCLEAR ENERG Y RESEARCH, Taoyuna (TW)

(21) Appl. No.: 12/010,308

(22) Filed: Jan. 23, 2008

(51) Int. Cl. G01N 21/35; G01B 11/14

(52) U.S. Cl. 356/51; 356/614

(57) ABSTRACT

There is disclosed an apparatus for measuring the displacement of a valve rod of a motor-operated valve between an open position and a closed position. The apparatus include a disc, a crank, an illuminator, an infrared sensor/transmitter and an infrared receiver. The disc is mounted on the valve rod. The crank is pivotally connected to the disc. The illuminator is pivotally connected to the crank. The infrared sensor/transmitter is attached to a lower side of the illuminator to measure the displacement of the valve rod and transmit a signal related to the displacement. The infrared receiver is connected to the valve rod to transfer the signal to a computer.

### BACKGROUND OF INVENTION

1. Field of Invention

The present invention relates to an apparatus for measuring the displacement of a valve rod of a motor-operated valve and transmitting a signal related to the displacement and, more particularly, to an apparatus for measuring the displacement of a valve rod of a ROTORK motor-operated valve and transmitting a signal related to the displacement.

2. Related Prior Art

A motor-operated valve is a mechanical device located in piping and operated by a motor to control the opening and closing of a valve door. Motor-operated valves are often found in nuclear power plants, thermal power plants, hydraulic power plants and chemical plants.

According to a regulation made by the NRC of the U.S.A., a nuclear power plant license holder must make plans to periodically test the ability of all safety-related motor-operated valves to continuously execute safety functions based on the current designs. At the present, in equipment for testing the thrust of a motor-operated valve, a valve rod displacement indicator includes a reel-type sensor to measure the displacement of a valve rod of the motor-operated valve between an open position and a closed position. However, the indicator can only be used to measure the displacement of the valve rod of a LIMITORQUE motor-operated valve, which includes screw holes for receiving a fastener for fastening the indicator. The indicator cannot be used to measure the displacement of a valve rod of a ROTORK motor-operated valve, which does not include any screw hole for receiving any fastener for fastening the indicator. Therefore, the use of the indicator is limited.

The present invention is therefore intended to obviate or at least alleviate the problems encountered in prior art.

### SUMMARY OF INVENTION

The primary objective of the present invention is to provide to an apparatus for measuring the displacement of a valve rod of a ROTORK motor-operated valve and transmitting a signal related to the displacement.

To achieve the foregoing objective, the apparatus include a disc, a crank, an illuminator, an infrared sensor/transmitter and an infrared receiver. The disc is mounted on the valve rod. The crank includes two sections and three pivotal devices. The first pivotal device is mounted on the disc. The first section is connected to the first pivotal device so that the angle thereof is adjustable. The second pivotal device is connected to the first section. The second section is connected to the second pivotal device so that the angle thereof is adjustable. The third pivotal device is connected to the second section. The illuminator is connected to the third pivotal device so that the angle thereof is adjustable. The infrared sensor/transmitter is attached to a lower side of the illuminator to measure the displacement of the valve rod and transmit a signal related to the displacement. The infrared receiver is connected to the valve rod to transfer the signal to a computer.

Other objectives, advantages and features of the present invention will become apparent from the following description referring to the attached drawings.

### BRIEF DESCRIPTION OF DRAWINGS

The present invention will be described via the detailed illustration of the preferred embodiment referring to the drawings.

FIG. 1 is a perspective view of an apparatus for detecting the displacement of a valve rod of a motor-operated valve and transmitting a displacement-related signal according to the preferred embodiment of the present invention.

FIG. 2 is a perspective view of a disc used in the apparatus of FIG. 1.

FIG. 3 is a flow chart of a process executed by the apparatus of FIG. 1.

### DETAILED DESCRIPTION OF PREFERRED EMBODIMENT

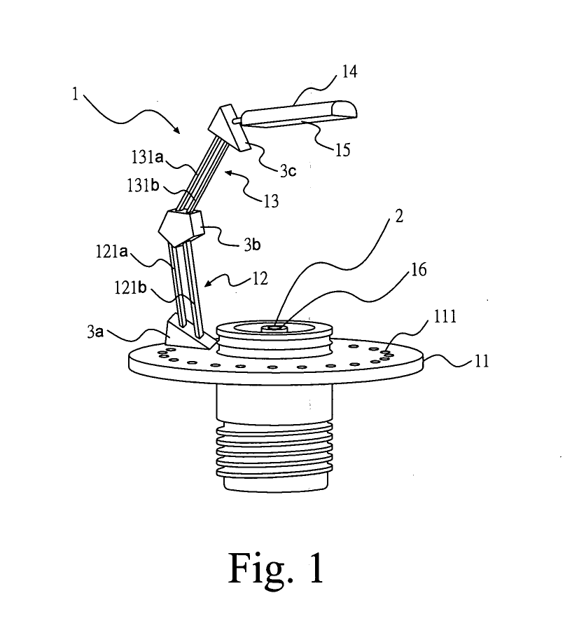

Referring to FIG. 1, there is shown an apparatus for measuring the displacement of a valve rod 2 of a motor-operated valve and transmitting a signal related to the displacement according to the preferred embodiment of the present invention. The apparatus includes a disc 11, a crank, an illuminator 14, an infrared sensor/transmitter 15 and an infrared receiver 16. The crank includes a lower section 12 and an upper section 13.

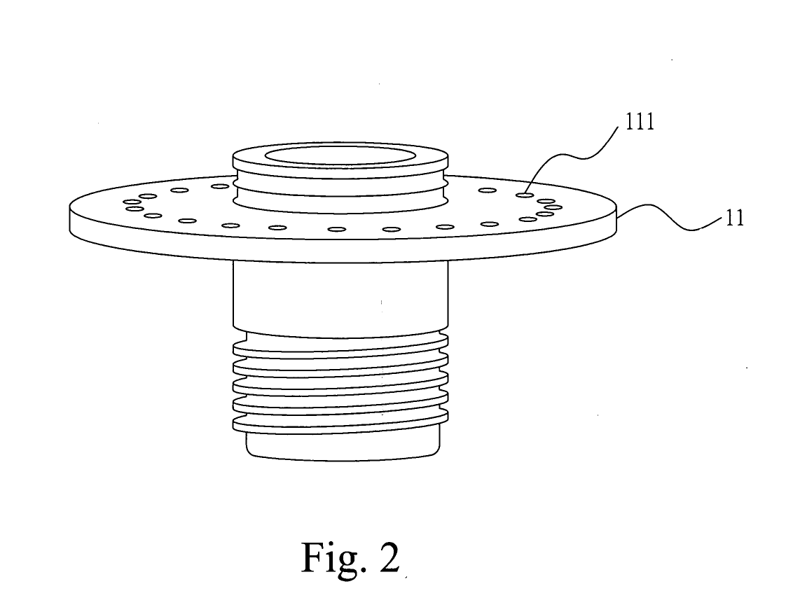

The disc 11 is made of stainless steel. The disc 11 is mounted on the valve rod 2. As best shown in FIG. 2, the disc 11 includes screw holes 111 defined therein and deployed along a circle.

A first pivotal device 3a includes a portion driven in one of the screw holes 111 of the disc 11. The lower section 12 of the crank is connected to the first pivotal device 3a. The angle of the lower section 12 of the crank is adjustable because of the first pivotal device 3a. The lower section 12 of the crank includes two rods 121a and 121b.

A second pivotal device 3b is connected to the lower section 12 of the crank. The upper section 13 of the crank is connected to the second pivotal device 3b. The angle of the upper section 13 of the crank is adjustable because of the second pivotal device 3b. The upper section 13 of the crank includes two rods 131a and 131b.

A third pivotal device 3c is connected to the upper section 13 of the crank. The illuminator 14 is connected to the third pivotal device 3c. The angle of the illuminator 14 is adjustable because of the third pivotal device 3c. The illuminator 14 includes an LED-based light source.

The infrared sensor/transmitter 15 is attached to a lower side of the illuminator 14 to measure the displacement of the valve rod 2 between an open position and a closed position of the motor-operated valve. The infrared sensor/transmitter 15 transmits a signal related to the displacement.

The infrared receiver 16 is mounted on the valve rod 2 corresponding to the infrared sensor/transmitter 15. The infrared receiver 16 transfers the signal from the infrared sensor/transmitter 15 to a computer to calculate the displacement.

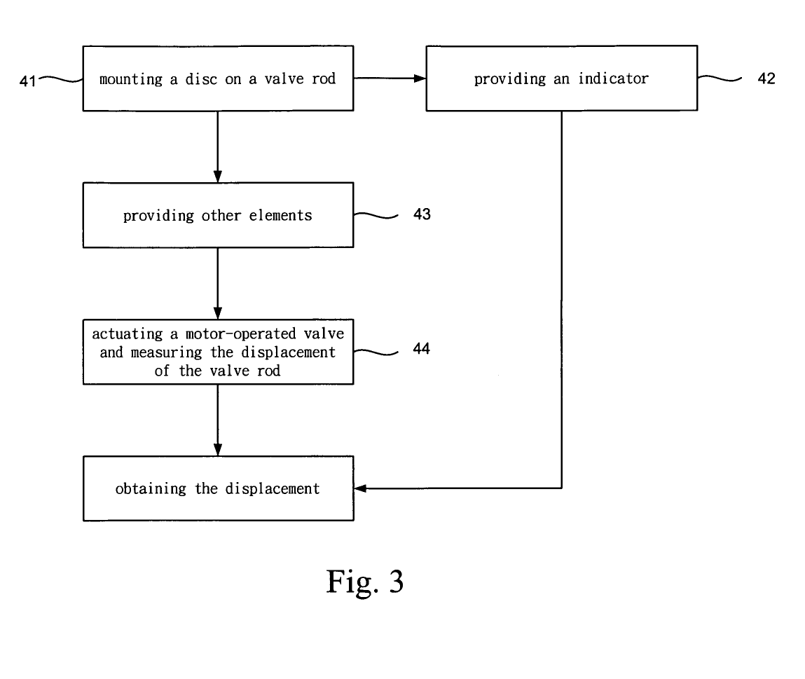

Referring to FIG. 3, there is shown a process executed by the apparatus shown in FIG. 1. At 41, the disc 11 is mounted on the valve rod 2 of the motor-operated valve.

At 42, an indicator that can only measure the displacement of the valve rod of a LIMITORQUE motor-operated valve originally is mounted on the disc 11. Thus, the indicator can measure the displacement of the valve rod 2 of the motor-operated valve in the original manner.

At 43, the sections 12 and 13 of the crank and the illuminator 14 are mounted on the disc 11 via the pivotal devices 3a, 3b and 3c. The portion of the first pivotal device 3a is driven in one of the screw holes 111 of the disc 11. The infrared sensor/transmitter 15 is attached to the lower side of the illuminator 14. The infrared receiver 16 is mounted on the valve rod 2. The pivotal devices 3a, 3b and 3c can hold the sections 12 and 13 of the crank and the illuminator 14 in any desired angles against the gravity.

At 44, the motor-operated valve is turned on, and the apparatus is turned on to measure the displacement of the valve rod 2 of the motor-operated valve. The infrared sensor/transmitter 15 measures the displacement of the valve rod 2 between an open position and a closed position of the motor-operated valve, and transmits the signal. The infrared receiver 16 transfers the signal from the infrared sensor/transmitter 15 to a computer to calculate the displacement.

As discussed above, the disc 11 renders it possible to mount the crank, the illuminator 14 and the infrared sensor/transmitter 15 on a ROTORK motor-operated valve, which originally does not include any screw hole to receive any fastener. The infrared sensor/transmitter 15 and the infrared receiver 16 together measure the displacement of the valve rod 2. An indicator originally intended for a LIMITORQUE motor-operated valve can now be used for a ROTORK motor-operated valve.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. An apparatus for measuring the displacement of a valve rod of a motor-operated valve between an open position and a closed position, the apparatus comprising:
a disc mounted on the valve rod;
a crank comprising:
a first pivotal device mounted on the disc;
a first section connected to the first pivotal device so that the angle of the first section is adjustable;
a second pivotal device connected to the first section;
a second section connected to the second pivotal device so that the angle of the second section is adjustable; and
a third pivotal device connected to the second section;
an illuminator connected to the third pivotal device so that the angle of the illuminator is adjustable;
an infrared sensor/transmitter attached to a lower side of the illuminator to measure the displacement of the valve rod and transmit a signal related to the displacement; and
an infrared receiver connected to the valve rod to transfer the signal to a computer.

2. The apparatus according to claim 1, wherein the disc is made of stainless steel.

3. The apparatus according to claim 1, wherein the disc comprises screw holes defined therein and deployed along a circle.

4. The apparatus according to claim 1, wherein the first section of the crank comprises two rods.

5. The apparatus according to claim 1, wherein the second section of the crank comprises two rods.

6. The apparatus according to claim 1, wherein the apparatus is used in a valve rod displacement indicator.

7. The apparatus according to claim 1, wherein the apparatus is used in a ROTORK motor-operated valve.
